(19) United States
(12) Patent Application Publication
(10) Pub. No.: US 2009/0284658 A1
(43) Pub. Date: Nov. 19, 2009

(54) IMAGE SIGNAL RECEIVER AND METHOD OF DISPLAYING PROGRESS BARS

(76) Inventor: Eun Hyung Cho, Gyeongsangbuk-do (KR)

Correspondence Address: KED & ASSOCIATES, LLP, P.O. Box 221200, Chantilly, VA, 20153-1200, US

(21) Appl. No.: 12/442,556

(22) PCT Filed: Sep. 27, 2007
(86) PCT No.: PCT/KR2007/004714

§ 371 Date: Mar. 24, 2009

(30) Foreign Application Priority Data
Sep. 25, 2006 (KR) 10-2006-0092789

(51) Int. Cl. H04N 5/50

(52) U.S. Cl. 348/569

(57) ABSTRACT

Disclosed herein are a broadcasting receiver for displaying a plurality of recorded broadcasting programs so as to be differentiated from one another and searching for, selecting and reproducing a specific program, and a method of displaying recorded data. A plurality of image contents processed by image processing is recorded, the image contents are recorded or the recorded image contents are read, and on-screen display (OSD) information of the recorded image contents is generated. A first progress bar (s120) for displaying the plurality of recorded image contents in the unit of blocks so as to be differentiated from one another and a second progress bar (s150) for displaying detailed information of any one of the image contents displayed in the first progress bar (s120) are generated, the read image contents are displayed on a screen, and the generated first and second progress bars (s120, s150)are displayed.

### TECHNICAL FIELD

The present invention relates to a broadcasting receiver for displaying a plurality of broadcasting programs so as to be differentiated from one another and searching for, selecting and reproducing a specific program, and a method of displaying recorded data.

### BACKGROUND ART

Recently, as a personal video recorder (hereinafter, abbreviated to a PVR) using a hard disk drive (hereinafter, abbreviated to a HDD) come into wide use, digital and analog broadcasting signals which are received via a television receiver can be recorded on a recording medium, which is a recorder, and can be reproduced.

Such a PVR is a new conceptual digital recorder for recording information on a hard disk and reproducing the information, unlike a conventional video cassette recorder (VCR) for recording an image signal on a magnetic tape. The PVR can record a predetermined amount of broadcasting program according to capacity thereof via a HDD included in a set top box or a television receiver, without using the VCR.

Further, recently, a time shift function for allowing a user to record a broadcasting signal, which is received in real time, on a hard disk of a PVR and to reproduce the broadcasting signal so as to provide pause, rewind and fast forward functions to a real-time broadcasting program has been developed and commercialized.

According to a conventional time shift function, when a user makes a request for executing the time shift function, a television broadcasting receiver temporarily records a broadcasting program received in real time in a time shift recording region of a recording unit, displays the amount of the broadcasting program recorded in the time shift recording region, and performs a time shift guide on-screen display (OSD) function for allowing the user to select and reproduce any one point of the recorded broadcasting program.

In the time shift guide OSD function, a progress bar for displaying a recording status of the broadcasting program is displayed. When the user specifies any one point of the progress bar, the broadcasting program which is recorded in correspondence with the point is read and reproduced, thereby reproducing the broadcasting program in real time.

However, in the conventional time shift guide OSD function, since only the recording status of the broadcasting program is displayed as shown in FIG. 1, it is difficult for the user to identify different broadcasting programs, which are continuously recorded. In particular, if a plurality of programs is recorded, in order to select a specific program to be reproduced, the user needs to intuitively search for a desired program by moving the progress bar.

### DISCLOSURE

### Technical Problem

An object of the present invention devised to solve the problem lies on a broadcasting receiver for displaying a plurality of block-based progress bars corresponding to a plurality of broadcasting programs such that the plurality of broadcasting programs are differentiated from one another and rapidly and conveniently searching for, selecting and reproducing a specific program, and a method of displaying recorded data.

### Technical Solution

The object of the present invention can be achieved by providing a broadcasting receiver including: a reception unit which receives a broadcasting signal or an external input signal; an image processing unit which processes the broadcasting signal or the external input signal to displayable image contents; a storage unit which records a plurality of image contents processed by the image processing unit; a control unit which controls the image contents to be recorded in the storage unit or the recorded image contents to be read; an on-screen display (OSD) generation unit which generates OSD information of the image contents recorded in the storage unit, and generates a first progress bar for displaying the plurality of image contents recorded in the storage unit in the unit of blocks so as to be differentiated from one another and a second progress bar for displaying detailed information of any one of the image contents displayed in the first progress bar; and a display unit which displays the image contents read from the storage unit on a screen and displays the first and second progress bars generated by the OSD generation unit.

The image contents may be broadcasting programs. The broadcasting signal may be an analog or digital television signal. The image processing unit may further include a decoder which decodes the received signal. The first progress bar may display at least one block according to types of programs. The first progress bar may display at least one block according to genres of programs. The first progress bar may display at least one block according to channels of programs. Blocks of the first progress bar may be moved and selected in the unit of programs. The second progress bar may be displayed on the same screen as the first progress bar. The second progress bar may be sequentially popped up and displayed whenever one program is selected in the first progress bar. The first progress bar or the second progress bar may display at least one of indicators indicative of time information, channel information, a title, a thumbnail and a recording position of the image contents. The indicator indicative of the recording position may be moved on the first progress bar or the second progress bar in the unit of blocks.

In another aspect of the present invention, provided herein is a method of displaying data recorded in a broadcasting receiver, the method including: receiving a broadcasting signal or an external input signal; processing the broadcasting signal or the external input signal to displayable image contents; recording a plurality of image contents processed by the processing step; controlling the image contents to be recorded or the recorded image contents to be read in the recording step; generating OSD information of the image contents recorded in the recording step, and generating a first progress bar for displaying the plurality of recorded image contents in the unit of blocks so as to be differentiated from one another and a second progress bar for displaying detailed information of any one of the image contents displayed in the first progress bar; and displaying the image contents read in the recording step on a screen and displaying the first and second progress bars generated by the generating step.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a screen status diagram showing a progress bar according to a time shift function of a conventional broadcasting receiver.

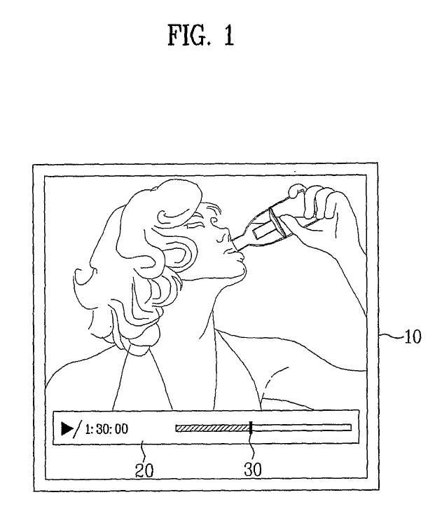

FIG. 2 is a schematic block diagram showing the configuration of a television receiver for recording and reproducing data according to an embodiment of the present invention.

FIG. 3 is a flowchart illustrating a method of displaying a progress bar of a time shift function according to an embodiment of the present invention.

FIGS. 4A to 4C are screen status diagrams showing progress bars of a time shift function according to an embodiment of the present invention.

FIGS. 5A and 5B are screen status diagrams showing progress bars of a time shift function according to another embodiment of the present invention.

### MODE FOR INVENTION

Reference will now be made in detail to the preferred embodiments of the present invention, examples of which are illustrated in the accompanying drawings.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

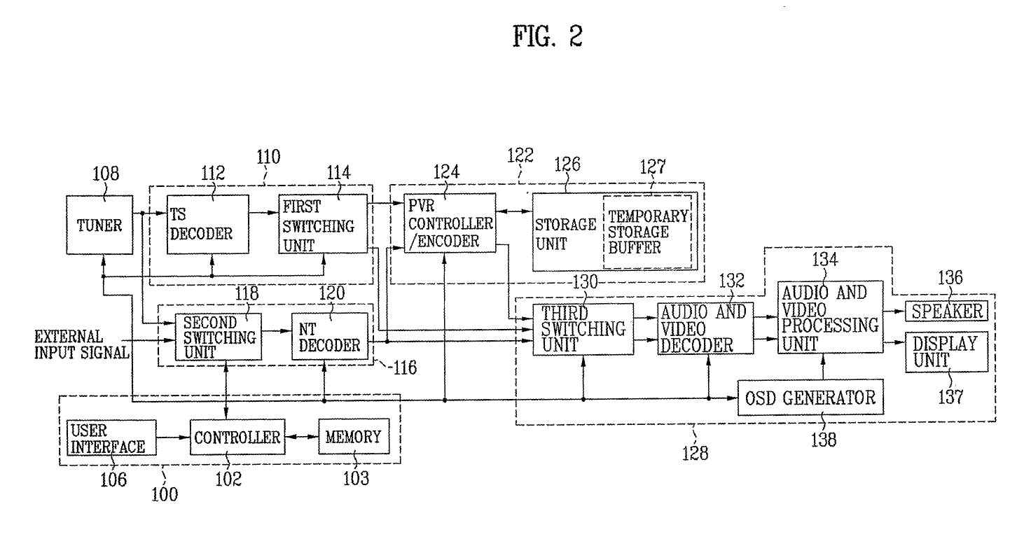

FIG. 2 is a schematic block diagram showing the configuration of a television receiver for recording and reproducing data according to an embodiment of the present invention.

As shown in FIG. 2, a broadcasting receiver according to the embodiment of the present invention is a television receiver including a PVR for recording and reproducing broadcasting data. The broadcasting receiver includes a control device 100 for controlling the whole operation of the television receiver, a tuner 108 for tuning a broadcasting channel under the control of the control device 100, a digital broadcasting signal processing unit 110 for processing a digital broadcasting signal, and an analog broadcasting signal processing unit 116 for processing an analog broadcasting signal, a PVR unit 122 for recording and reproducing the digital broadcasting signal or the analog broadcasting signal, and a broadcasting signal output unit 128 for outputting the broadcasting data provided by the digital broadcasting signal processing unit 110, the analog broadcasting signal processing unit 116 or the PVR unit 122.

The control device 100 includes a controller 102, a memory 103, and a user interface 106.

The controller 102 controls the whole operation of the television receiver. In particular, the controller 102 controls an operation of a first progress bar for displaying the statuses of broadcasting programs which have been recorded up to now by a time shift function according to the embodiment of the present invention and an operation of a second progress bar for extending and displaying an a program which is selected by a user in the first progress bar.

At this time, the controller 102 displays the first progress bar which is divided in the unit of blocks according to the types, channels or genres of the programs recorded in the PVR unit 122.

The first progress bar includes an indicator which can select one of programs which are divided in the unit of blocks. The indicator indicates a recording position and is moved on a block-by-block basis according to the input of a signal by the user.

The memory 103 stores a variety of information including a system program of the controller 102 and stores an automatic reproduction setting mode according to the display of the second progress bar.

The user interface 106 is a key pad or a remote controller included in the television receiver and transmits a variety of commands or information input by the user to the controller 102.

In the present invention, the user interface 106 receives a signal for moving a first indicator included in the first progress bar and a signal for moving a second indicator included in the second progress bar and transmits the signals to the controller 102.

The tuner 108 tunes a channel according to the control of the controller 102 in the broadcasting data input via air wave broadcast or cable, supplies a digital broadcasting signal of the broadcasting signal received via the tuned channel to the digital broadcasting signal processing unit 110, and supplies an analog broadcasting signal to the analog broadcasting signal processing unit 116.

The digital broadcasting signal processing unit 110 includes a TS decoder 112 and a first switching unit 114.

The TS decoder 112 decodes the digital broadcasting signal supplied by the tuner 108 to audio, video and data streams and transmits the audio, video and data streams to the first switching unit 114.

The first switching unit 114 supplies the audio, video and data streams to the PVR unit 122 and/or the broadcasting signal output unit 128, under the control of the controller 102.

The analog broadcasting signal processing unit 116 includes a second switching unit 118 and an NT (NTSC) decoder 120.

The second switching unit 118 receives the analog broadcasting signal supplied by the tuner 108 and an external input signal and selects and supplies any one of the signals to the NT (NTSC) decoder 120 under the control of the controller 102.

The NT decoder 120 receives the analog broadcasting signal or the external input signal, decodes the analog broadcasting signal or the external input signal to audio data and video data, and supplies the audio data and the video data to the PVR unit 122 and the broadcasting signal output unit 128.

The PVR unit 122 includes a PVR controller/encoder 124 and a storage unit 126.

The PVR controller/encoder 124 receives and records the audio, video and data streams output from the digital broadcasting signal processing unit 110 in the storage unit 126 or MPEG-encodes the audio data and the video data output from the analog broadcasting signal processing unit 116 to audio and video streams and records the audio and video streams in the storage unit 126.

The storage unit 126 is a hard disk driver including a hard disk and records the audio, video and data streams supplied by the PVR controller/encoder 124.

As described above, the storage unit 126 records the received audio, video and data stream and audio and video streams obtained by encoding the external input signal and supplies the data output from the PVR controller/encoder 124.

The broadcasting signal output unit 128 includes a third switching unit 130, an audio and video decoder 132, an audio and video processing unit 134, a speaker 136 and a display unit 137.

The third switching unit 130 selects and supplies at least one of the outputs of the digital signal processing unit 110, the analog signal processing unit 116 and the PVR unit 122 to the audio and video decoder 132, under the control of the controller 102.

The audio and video decoder 132 decodes the video and audio streams to video and audio data and supplies the video and audio data to the audio and video processing unit 134 if the video and audio streams are received, and supplies the video and audio data to the audio and video processing unit 134 without performing a decoding operation if the video and audio data are received.

The audio and video processing unit 134 is an image processing unit which processes audio and video signals. The audio and video processing unit 134 processes at least one piece of audio and video data supplied by the audio and video decoder, outputs the audio data to the speaker 136 and, outputs the video data to the display unit 137.

The audio and video processing unit 134 mixes OSD data supplied by the controller 102 to the video data and supplies the mixed signal to the display unit 137.

If the user makes a request for a progress guide display according to the time shift function, an OSD generator 138 generates the first progress bar for displaying the status of the broadcasting programs recorded in the storage unit 126 up to now and supplies the first progress bar to the audio and video processing unit 124, under the control of the controller 102.

If the user selects one of the programs in the first progress bar, the OSD generator generates and supplies the second progress bar for displaying the information on the selected program to the audio and video processing unit 124.

The display unit 137 may simultaneously display the first progress bar and the second progress bar supplied by the OSD generator 138 according to the time shift function, under the control of the controller 102. Alternatively, the display unit 137 may first display the first progress bar and then display the second progress bar if a specific program block is selected in the first progress bar.

Hereinafter, a method of displaying the progress bar of recorded data according to an embodiment of the present invention, which is applicable to the television receiver having the PVR function, will be described.

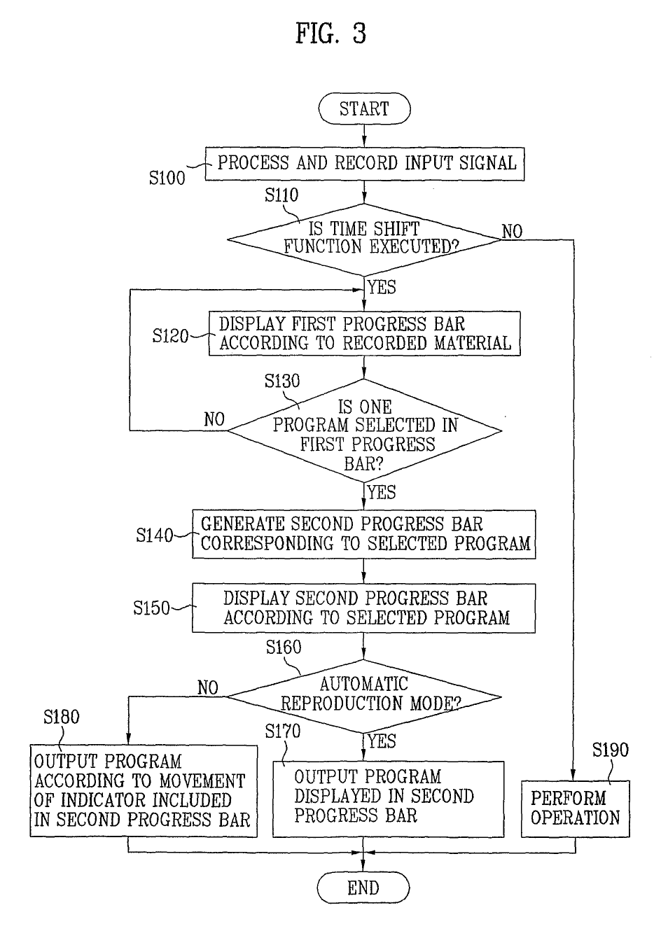

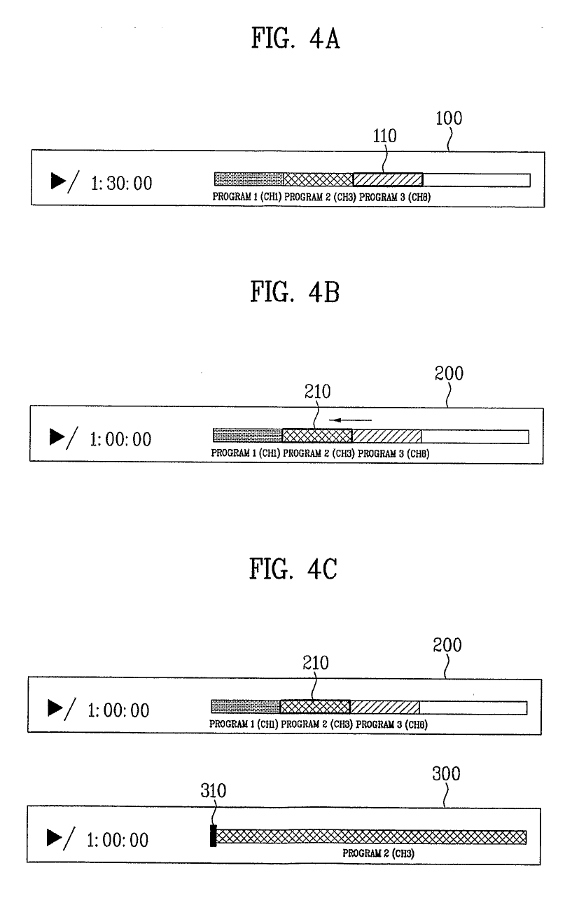

FIG. 3 is a flowchart illustrating a method of displaying a progress bar of a time shift function according to an embodiment of the present invention. FIGS. 4A to 4C are screen status diagrams showing progress bars of a time shift function according to an embodiment of the present invention.

The method of displaying the progress bar according to the embodiment of the present invention shown in FIG. 3 will be described together with FIGS. 4A to 4C.

First, as shown in FIG. 3, the controller 102 of the television receiver which is the broadcasting receiver processes and records an image signal of a broadcasting program received via the tuner 108 in the storage unit 126 of the PVR unit 122 (S100).

If the user executes the time shift function via the user interface 106 (S110), the controller 102 supplies the first progress bar for guiding the progress according to the time shift function, that is, supplies the broadcasting programs recorded in the storage unit 126 up to now in the first progress bar, on the lower side of the screen of the television receiver (S120).

Referring to FIG. 4A, the controller 102 displays three broadcasting programs recorded in the PVR unit 122 up to now in the first progress bar 200 by the time shift function. At this time, the first progress bar 200 displays the three programs recorded in the PVR unit 122 in the unit of blocks according to the types, channels or genres of the programs.

Here, three blocks are indicative of programs having different types, channels or genres and are displayed with different colors. The programs recorded in the PVR unit 122 are displayed in the unit of blocks, and storage space blocks in which a program will be recorded in the storage unit 126 in future are also displayed.

The first progress bar 200 includes a first indicator 210 for selecting one of the programs displayed in the unit of blocks. The first indicator 210 is moved in the unit of blocks.

In FIG. 4A, in a state in which the user inputs the time shift function and the first progress bar 200 is provided, the first indicator 210 is located at the block “Program 3” which is currently being recorded by the time shift function. Accordingly, a program which is currently being displayed on the screen of the television receiver is “Program 3”.

That is, the first progress bar 200 which is provided at the time of execution of the time shift function displays a plurality of program blocks in which trick-playable programs are recorded and blocks in which data will be recorded in future. A block at which the first indicator 210 is located is a program which is currently being recorded or progressed.

Thereafter, a movement signal of the first indicator 210 is input through the user interface 106 to select one program on the first progress bar (S130). That is, if the first indicator 210 included in the first progress bar 200 is moved to the block, in which “Program 2” is recorded, as shown in FIG. 4B, the controller 102 detects “Program 2” recorded in correspondence with the block, at which the first indicator 210 is located, from the PVR unit 122 and generates a second progress bar 300 (S140).

Subsequently, the controller 102 displays the second progress bar 300 of “Program 2” recorded in correspondence with the block, at which the first indicator 210 is located, in the first progress bar 200 (S150).

It is determined whether the program recorded in the PVR unit 122 is an automatic reproduction mode for simultaneously selecting and reproducing the program (S160). If it is determined that the reproduction mode is set, the program displayed in the second progress bar 300, that is, “Program 2” is automatically reproduced (S170).

Referring to FIG. 4C, the first progress bar 200 for displaying the programs, which have been recorded in the storage unit 126 up to now according to the time shift function, so as to be differentiated from one another in the unit of blocks, and the second progress bar 300 for extending and displaying only one program corresponding to the block, at which the first indicator 210 is located, in the first progress bar 300 are displayed.

The second indicator 300 includes a second indicator 310 for selecting a start point of the program. The second indicator 310 can be horizontally moved such that the progress time or the amount of the current program can be displayed at the time of the reproduction of the program.

At this time, the first indicator 310 included in the second progress bar 300 is located at the start point of the selected program such that the program can be reproduced while the second progress bar 300 is displayed, and is moved by the selection of the user such that the user can set the start point.

Meanwhile, if it is determined that the automatic reproduction mode for selecting and reproducing the program according to the second progress bar 300 is not set, then the controller 102 trick-plays or reproduces the program according to the movement of the second indicator 310 included in the second progress bar 300 (S180).

The program displayed in the second progress bar 300 is output on the screen of the television receiver such that the user can more easily select and reproduce a desired program.

The first progress bar 200 and the second progress bar 300 selectively display at least one of time information, channel information, a title, and a thumbnail image information of the recorded program. Accordingly, the user can more easily identify the recorded programs.

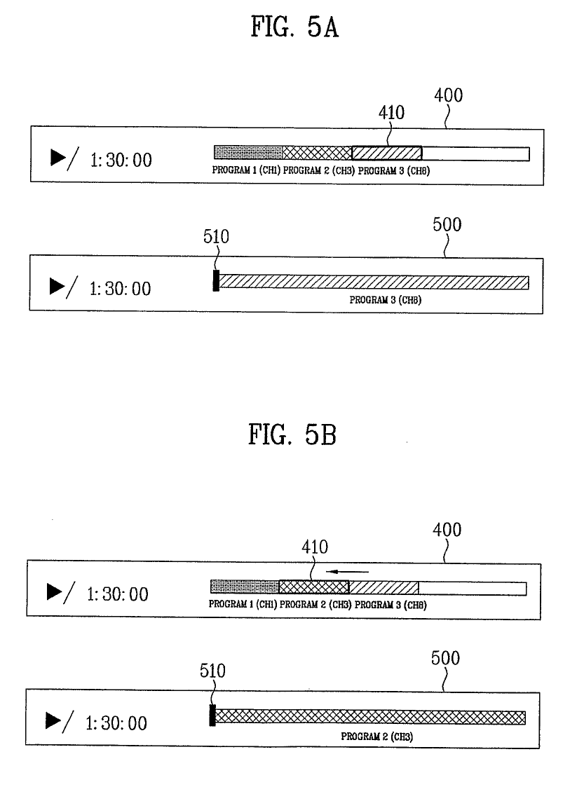

FIGS. 5A and 5B are screen status diagrams showing progress bars of a time shift function according to another embodiment of the present invention.

As shown in FIG. 5A, when the user executes the time shift function using the user interface 106, the controller 102 supplies the progress bar according to the time shift function, that is, a first progress bar 400 for displaying broadcasting programs which have been recorded in the storage unit 126 up to now and a second progress bar 500 for displaying only one program corresponding to a block, at which a first indicator 410 is located, in the first progress bar 400 together, on the screen of the television receiver.

At this time, the first progress bar 400 displays three broadcasting programs including “Program 1 (CH1)”, “Program 2 (CH3)”, and “Program 3 (CH8)” recorded by the time shift function so as to be differentiated from one another in the unit of blocks according the types, channels or genres of the programs.

Here, three blocks are indicative of programs having different types, channels or genres and are displayed with different colors. The programs recorded in the PVR unit 122 are displayed in the unit of blocks and storage space blocks in which a program will be recorded in the storage unit 126 in future are also displayed.

Here, since the first indicator 410 included in the first progress bar 400 is located at the “Program 3”, it can be seen that the “Program 3” is being provided to or recorded in the television receiver.

Thereafter, as shown in FIG. 5A, when the user moves the first indicator 410 located at the “Program 3” to a previous block, the controller 102 changes the program provided by the second progress bar 500 to the program recorded in correspondence with the block, at which the first indicator 410 is located, and displays the program.

That is, whenever the first indicator 410 included in the first progress bar 400 is moved, the program, channel, or genre provided by the second progress bar 500 is changed and displayed.

Subsequently, when the “Program 2” recorded in correspondence with the block, at which the first indicator 410 is located, is selected in the first progress bar 400 and is displayed in the second progress bar 500, the controller 102 reproduces the “Program 2” or outputs data corresponding to a point selected according to the movement of the second indicator 510 included in the second progress bar 500.

Although the television receiver is described as the broadcasting receiver in the embodiment of the present invention, the present invention is not limited to the television receiver and is applicable to a set top box (STB) for receiving and recording a broadcasting signal or an apparatus for receiving other broadcasting signals. When contents recorded in the storage medium such as a HDD, such as broadcasting programs and external input signals received from external apparatuses, are displayed in a progress bar by the time shift function, the recorded contents can be displayed so as to be differentiated from one another according to the genres or input signals.

According to the present invention, since the first progress bar for displaying information on the programs, which have been recorded in the storage medium up to now at the time of the execution of the time shift function, is displayed so as to be differentiated from one another according to the types, channels or genres of the programs, the user can more easily identify the recorded program and can rapidly search for a program to be reproduced.

Since one program selected in the first progress bar is provided to the second progress bar, it is possible to more accurately, rapidly or conveniently select a reproduction point of a program to be reproduced.

Other implementations are within the scope of the following claims.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A broadcasting receiver, comprising:
a reception unit which receives a broadcasting signal or an external input signal;
an image processing unit which processes the broadcasting signal or the external input signal to displayable image contents;
a storage unit which records a plurality of image contents processed by the image processing unit;
a control unit which controls the image contents to be recorded in the storage unit or the recorded image contents to be read;
an on-screen display (OSD) generation unit which generates OSD information of the image contents recorded in the storage unit, and generates a first progress bar for displaying the plurality of image contents recorded in the storage unit in the unit of blocks so as to be differentiated from one another and a second progress bar for displaying detailed information of any one of the image contents displayed in the first progress bar; and
a display unit which displays the image contents read from the storage unit on a screen and displays the first and second progress bars generated by the OSD generation unit.

2. The broadcasting receiver according to claim 1, wherein the image contents are broadcasting programs.

3. The broadcasting receiver according to claim 1, wherein the broadcasting signal is an analog or digital television signal.

4. The broadcasting receiver according to claim 1, wherein the image processing unit further includes a decoder which decodes the received signal.

5. The broadcasting receiver according to claim 1, wherein the first progress bar displays at least one block according to types of programs.

6. The broadcasting receiver according to claim 1, wherein the first progress bar displays at least one block according to genres of programs.

7. The broadcasting receiver according to claim 1, wherein the first progress bar displays at least one block according to channels of programs.

8. The broadcasting receiver according to claim 1, wherein blocks of the first progress bar are selectable in the unit of programs.

9. The broadcasting receiver according to claim 1, the second progress bar is displayed on the same screen as the first progress bar.

10. The broadcasting receiver according to claim 1, wherein the second progress bar is sequentially popped up and displayed whenever one program is selected in the first progress bar.

11. The broadcasting receiver according to claim 1, wherein the first progress bar or the second progress bar displays at least one of indicators indicative of time information, channel information, a title, a thumbnail and a recording position of the image contents.

12. The broadcasting receiver according to claim 11, wherein the indicator indicative of the recording position is moved on the first progress bar or the second progress bar in the unit of blocks.

13. A method of displaying data recorded in a broadcasting receiver, the method comprising:
receiving a broadcasting signal or an external input signal;
processing the broadcasting signal or the external input signal to displayable image contents;
recording a plurality of image contents processed by the processing step;
controlling the image contents to be recorded or the recorded image contents to be read in the recording step;
generating OSD information of the image contents recorded in the recording step, and generating a first progress bar for displaying the plurality of recorded image contents in the unit of blocks so as to be differentiated from one another and a second progress bar for displaying detailed information of any one of the image contents displayed in the first progress bar; and
displaying the image contents read in the recording step on a screen and displaying the first and second progress bars generated by the generating step.

14. The method according to claim 13, wherein the image contents are broadcasting programs.

15. The method according to claim 13, wherein the broadcasting signal is an analog or digital television signal.

16. The method according to claim 13, wherein the processing step further includes decoding the received signal.

17. The method according to claim 13, wherein the first progress bar displays at least one block according to types of programs.

18. The method according to claim 13, wherein the first progress bar displays at least one block according to genres of programs.

19. The method according to claim 13, wherein the first progress bar displays at least one block according to channels of programs.

20. The method according to claim 13, wherein blocks of the first progress bar are moved and selected in the unit of programs.

21. The method according to claim 13, the second progress bar is displayed on the same screen as the first progress bar.

22. The method according to claim 13, wherein the second progress bar is sequentially popped up and displayed whenever one program is selected in the first progress bar.

23. The method according to claim 13, wherein the first progress bar or the second progress bar displays at least one of indicators indicative of time information, channel information, a title, a thumbnail and a recording position of the image contents.

24. The method according to claim 23, wherein the indicator indicative of the recording position is movable on the first progress bar or the second progress bar in the unit of blocks.
